(19) United States
(12) Patent Application Publication
(10) Pub. No.: US 2025/0103936 A1
(43) Pub. Date: Mar. 27, 2025

(54) SYSTEMS AND METHODS FOR SWITCHABLE FIBER-BASED ION ADDRESSING SCHEME

(71) Applicant: IonQ, Inc., College Park, MD (US)

(72) Inventors: Joachim WELTE, Carrboro, NC (US); Kai Hudek, Hyattsville, MD (US)

(21) Appl. No.: 18/897,992

(22) Filed: Sep. 26, 2024

Related U.S. Application Data
(60) Provisional application No. 63/585,428, filed on Sep. 26, 2023.

(51) Int. Cl. G06N 10/40; G21K 1/00

(52) U.S. Cl. CPC G06N 10/40; G21K 1/006

(57) ABSTRACT

Aspects of the present disclosure relate generally to systems and methods for use in the implementation and/or operation of quantum information processing (QIP) systems, and more particularly, to various aspects of optical addressing systems configured to individually address multiple ions of a chain of ions trapped within an ion trap. In some aspects, the trapped ions have non-equidistant spacing.

### CROSS-REFERENCE TO RELATED APPLICATION

This application claims the benefit of U.S. Provisional Patent Application No. 63/585,428, filed Sep. 26, 2023, and hereby incorporates by reference herein the contents of this application.

### TECHNICAL FIELD

Aspects of the present disclosure relate generally to systems and methods for use in the implementation, operation, and/or use of quantum information processing (QIP) systems.

### BACKGROUND

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different QIP systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of optical addressing systems configured to individually address multiple ions of a chain of ions trapped within an ion trap. In some aspects, the trapped ions have non-equidistant spacing.

In some aspects, a quantum information processing (QIP) system includes a laser source configured to generate one or more addressing beams and a fiber switchboard configured to dynamically switch at least one of the one or more addressing beams between a plurality of channels that are aligned with one or more qubits, respectively, in an ion trap. The one or more addressing beams includes a first addressing beam and the plurality of channels includes a first channel and a second channel. The fiber switchboard has a first orientation in which the first addressing beam is aligned with the first channel and not aligned with the second channel and a second orientation in which the first addressing beam is aligned with the second channel and not aligned with the first channel.

In some aspects a quantum information processing (QIP) system includes a laser source configured to generate M number of addressing beams, wherein M is at least one and a fiber switchboard configured to dynamically realign at least one of the M number of addressing beams from a first channel to a second channel of a plurality of channels that are aligned with one or more qubits, respectively, in an ion trap, wherein the plurality of channels includes N number of channels. The number M of addressing beams is less than the number N of channels.

In some aspects, a quantum information processing (QIP) system includes a processor and a memory. The processor is configured to execute computer executable instructions in the memory to: determine that a particular addressing beam of one or more addressing beams should be aligned with a particular channel of a plurality of channels, wherein each of the plurality of channels is aligned with a particular qubit in an ion trap; and actuate a switch of a fiber switchboard to align the particular addressing beam with the particular channel. The switch includes a plurality of positions configured to align the particular addressing beam with one of the plurality of channels while not aligning the particular addressing beam with the others of the plurality of channels.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions of a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates a schematic representation of a system including a fiber switchboard configured to dynamically switch M addressing beams onto N different optical addressing channels configured to address N qubits in accordance with aspects of this disclosure.

FIG. 4A illustrates a detail view of a distortion correction system of the system of FIG. 4 in accordance with aspects of this disclosure.

FIG. 5A illustrates a schematic representation of another system including a fiber switchboard configured to dynamically switch M addressing beams onto N different optical addressing channels configured to address N qubits in accordance with aspects of this disclosure.

FIG. 5B illustrates a schematic representation of another system including a fiber switchboard configured to dynamically switch M addressing beams onto N different optical addressing channels configured to address N qubits in accordance with aspects of this disclosure.

FIG. 6 illustrates a method for directing (or redirecting) the M beams of the system of FIGS. 4, 5A, or 5B onto N different optical addressing channels configured to address N qubits in accordance with aspects of this disclosure.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

Quantum computing systems involve addressing ions trapped in a linear crystal and ion chain or in a two-dimensional arrangement in which N beams are arranged in a 2D lattice, for example an O×P matrix that includes O atoms in a first direction and P atoms in a second direction. In such aspects, the N beams address e.g., N=O×P neutral atom qubits in a 2D lattice. However, addressing individual trapped ions with non-equidistant spacing can be challenging. For example, the conventional systems described below use a number N of evenly spaced optical addressing channels to address a number N of trapped ions in an ion chain. However, the spacing between the trapped ions may be non-equidistant. This can cause the addressing beams to address the trapped ions in a non-optimal manner. In general, for purposes of this disclosure, addressing ions in an “optimal” manner means that the individual beam is telecentric and centered on the respective ion with the correct tilt and the like, such that the beam is not missing the ion or only partially hitting the ion, for example. Telecentric beams are optimal because they are first-order insensitive to certain alignment errors, like defocus and tilt. Telecentricity removes any projection of the difference of the k-vector of the counterpropagating or copropagating Raman beams on the ion chain axis, which would lead to momentum transfer to the ions and heating. Also, telecentric systems are more robust to drifts along the optical axis, because the spacing between the beams remains the same and the beams are still centered (albeit slightly defocused) on the ions.

For example, some conventional systems may use multi-channel acousto-optic modulators (AOMs) to direct beams to each of the trapped ions. However, such systems typically have restricted fields of view and the beam spacing produced by such a system cannot be optimally mapped onto non-equidistant ion locations. Further, such systems have a limited number of channels that can be used to direct beams onto particular ions. This can make such a system difficult to use for longer length ion chains. In such systems, only a subset, typically two, of the channels are used to address qubits at any particular time, meaning that the other channels are simply turned off, which results in a loss of laser power. Additionally, the required laser power scales with the number N of qubit locations that need to be addressable.

Other conventional systems may use a microelectromechanical systems (MEMS)-based scanner to flexibly map addressing beams onto an ion chain or a pair of acousto-optic deflectors (AOD) to map at least two beams onto an ion chain. However, such systems can be difficult to scale up because running a number M of parallel single qubit gate operations requires increasing the available laser power in the system by a number M²/2. This is a consequence of the requirement of “optimal” mapping and the brightness theorem. Therefore, the number of parallel qubit gate operations in such a system is limited by the available laser power.

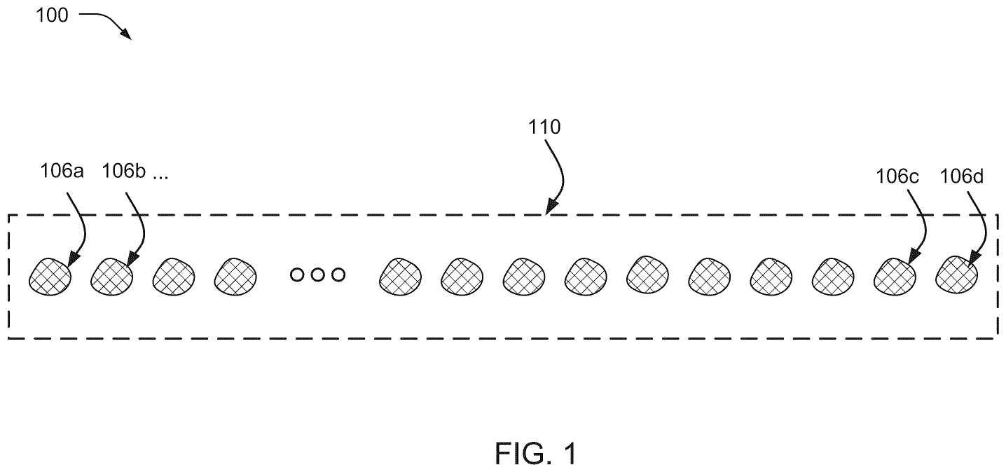

Solutions to the issues described above are explained in more detail in connection with FIGS. 1-6, with FIGS. 1-3 providing a background of QIP systems or quantum computers, and more specifically, of atomic-based QIP systems or quantum computers.

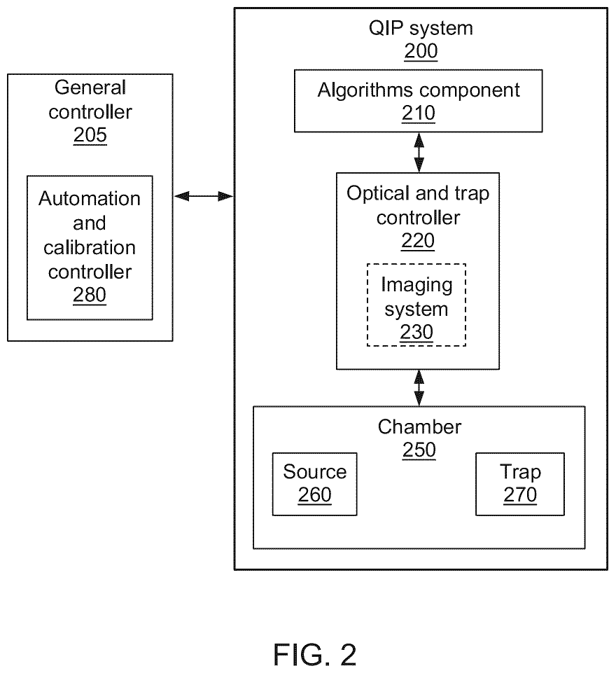

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be Ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to Ytterbium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements and non-linear confinements such as 2D and 3D lattices. Thus, a confinement device may be based on different techniques and may hold ions, neutral atoms, or Rydberg atoms, for example, with an ion trap being one example of such a confinement device. The ion trap may be a surface trap, for example.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facilitate such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (e.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using the optical systems and the optical and trap controller 220.

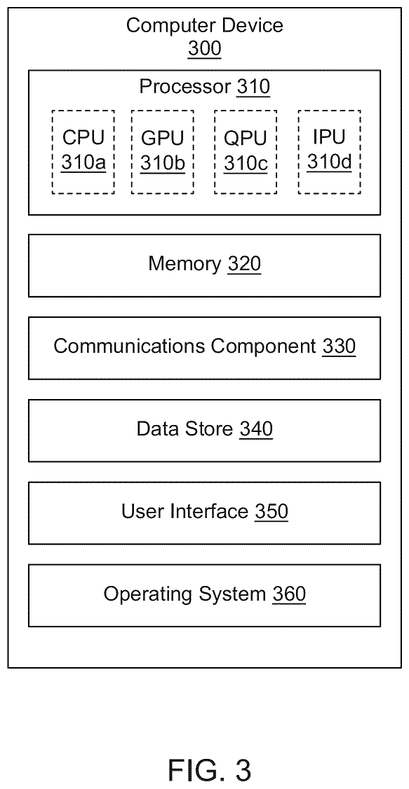

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

In connection with the systems described in FIGS. 1-3, the aspects described herein provide a fiber-based switching system for addressing multiple ions in a chain of trapped ions 272a . . . 272n. In general, a qubit is the basic unit of information in the quantum computing systems according to the example aspects described herein. In this example, the state of the ions (e.g., trapped ions 272a to 272n) can represent qubits according to an example aspect. The aspects described herein are configured to use N equally spaced channels to map to N ions that may have non-equidistant spacing between adjacent ions. For example, based on the design of the trap 270, spacing between adjacent ions may follow a fourth order function. In such aspects, the trapped ions 272a . . . 272n positioned proximate a center of the ion chain are substantially equidistantly spaced, but the spacing between adjacent trapped ions 272a . . . 272n increases toward the end of the ion chain. In some aspects, the systems described herein can be used for parallel addressing of quantum gates. The systems described herein also may be scalable to larger chains, for example chains including more than 32 trapped ions 272a . . . 272b. Further, when addressing multiple qubits, the systems described herein may more efficiently use laser power as the scale of the system is increased.

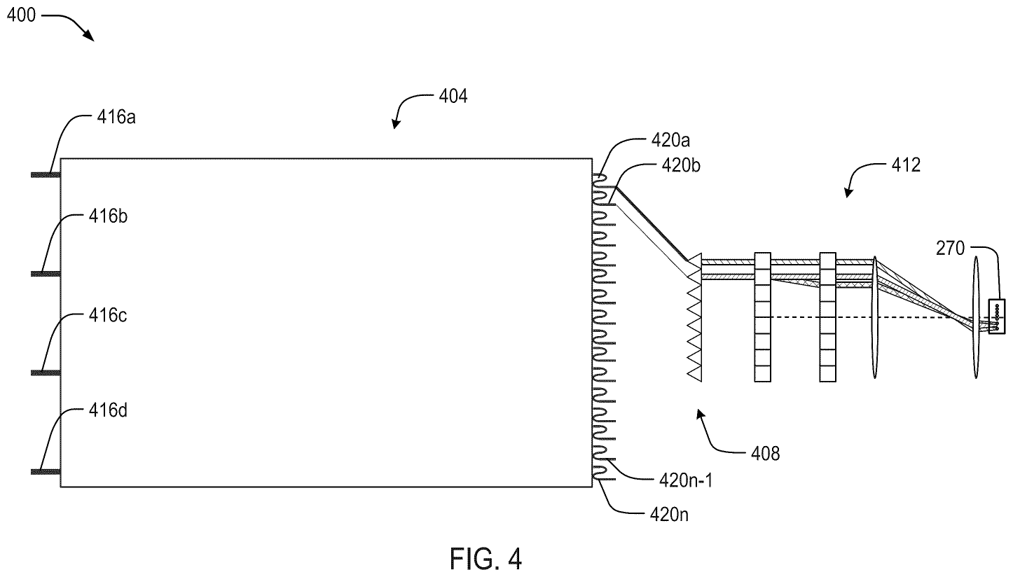

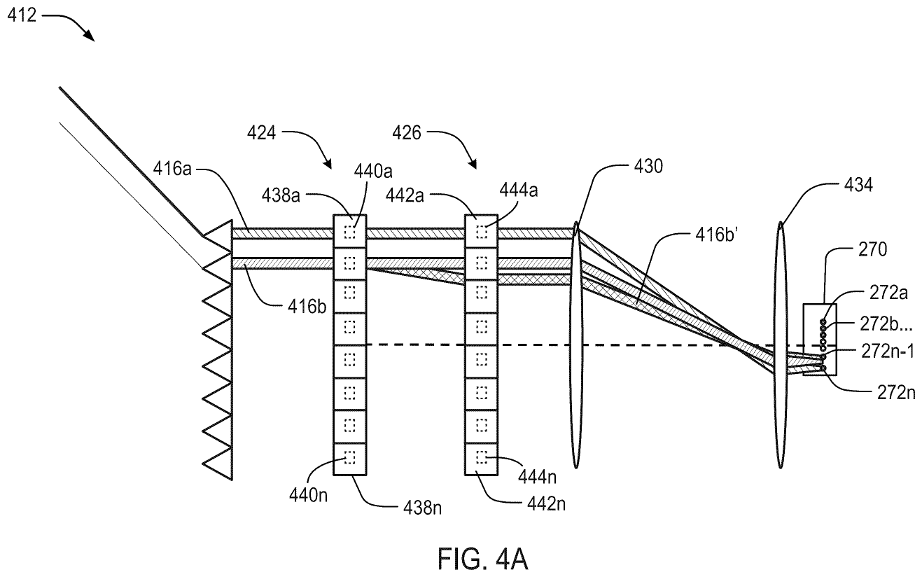

FIG. 4 illustrates a schematic representation of a M×N system 400 configured to address one or more qubits. As used herein, the variable N refers to the number of trapped ions 272a . . . 272n (FIG. 4A). The variable M refers to a number of addressing beams used by the system 400. A laser source may be configured to produce the addressing beams, and a splitter may be used to split an initial beam produced by the laser source into the M addressing breams. In the systems described herein, the number of beams M is smaller than the number N of channels. In the systems described herein, the number N is at least two. The system 400 is configured to dynamically and flexibly switch M beams onto N different optical addressing channels configured to address N trapped ions 272a . . . 272n in the ion trap 270. Such a configuration can allow for simultaneous operation of M/2 2-qubit gates with laser power scaling proportionally to the number M of simultaneously existing addressing beams, while still allowing addressing of all N qubits simultaneously. In operation in a QIP system, such as the QIP system 200, two systems 400 may be used. In such configurations, the second system 400 would be noncollinear with the system 400, such as on the opposite side of the ion trap 270 and symmetric to the system 400 of FIG. 4, forming M pairs of counterpropagating beams.

The system 400 includes a fiber switchboard 404, a v-groove fiber array 408, and a distortion correction system 412. Additional exemplary distortion correction systems are described in greater detail in U.S. patent application Ser. No. 18/785,919, filed Jul. 26, 2024 and titled “Systems and Methods for MEMS-Based Scalable Large Field-of-View Parallel Quantum Gate Control System”, which is hereby incorporated by reference herein in its entirety. The fiber switchboard 404 is configured to receive M beams 416a-416d from a source such as a laser and dynamically switch the M beams 416a-416d between the N channels 420a . . . 420n aligned with the N qubits. Although the configuration of FIG. 4 shows four addressing beams, other aspects may include more or fewer addressing beams. Since the M beams 416a-416d are dynamically switched between the N channels 420a . . . 420n, laser power only needs to be provided to the active channels 420a . . . 420n (e.g., channels that are currently being used to address the ions 272a . . . 272n). In contrast, conventional systems typically provide laser power to all N channels 420a . . . 420n while the QIP system 200 is running. Therefore, the fiber switchboard 404 improves laser power savings in the system 400 relative to conventional systems without switched addressing breams.

Each of the channels 420a . . . 420n includes a fiber optic element configured to direct the beams 416a-416d to the fiber V-groove array 408. The fiber V-groove array 408 is configured to align the channels 420a . . . 420n with the distortion correction system 412.

The distortion correction system 412 is configured to correct distortions of the addressing beams 416a . . . 416d and/or compensate for non-equidistant spacing between adjacent ions 272a . . . 272n. For example, in some aspects, the beams 416a . . . 416d leaving the fiber V-groove array 408 are evenly spaced. In such aspects, the distortion correction system 412 may be configured to compensate for non-equidistant spacing between adjacent ions 272a . . . 272n by redirecting respective beams 416a . . . 416d to be telecentric with corresponding ions 272a . . . 272n. In another example, the distortion correction system 412 can be configured to compensate for vibrations, drift, and/or pointing error. As illustrated in FIG. 4A according to an example aspect, in the illustrated configuration, the distortion correction system 412 includes a first mirror array 424, a second mirror array 426, a first lens 430, and a second lens 434. In some aspects, the first mirror array 424 is configured to position the addressing beams 416a . . . 416d beams for projection onto the trapped ions 272a . . . 272n. In some aspects, the second mirror array 426 is configured to correct tilt in the addressing beams 416a . . . 416d. The distortion correction system 412 may also further include one or more optical elements or additional optical relays for beam size matching, magnification, and so forth. In some aspects, one or more optical elements or optical relays may be positioned between the first mirror array 424 and the second mirror array 426.

The first mirror array 424 includes a first plurality of mirrors or groups of mirrors 438a . . . 438n. Each of the mirrors or groups of mirrors 438a . . . 438n is coupled to an actuator 440a . . . 440n (FIG. 4A) that is configured to reposition the mirror 438a . . . 438n. In the illustrated configuration, the actuators 440a . . . 440n include MEMS actuators. The actuators 440a . . . 440n are repositionable (e.g., by the optical and trap controller 220) to reposition a particular mirror or group of mirrors 438a . . . 438n to direct a beam 416a . . . 416d to a particular mirror or group of mirrors in the second mirror array 426. For example, the actuators 440a . . . 440n are configured to tune the angles of the mirrors 438a . . . 438n to map the N beams to N locations in the field of view (FOV). As described in greater detail below, the N locations include the N mirrors in the second mirror array 426. For example, in the configuration shown in FIG. 4, the mirror or group of mirrors 438a is oriented to direct a first beam 416a to a first mirror or group of mirrors 442a of the second mirror array 426. The mirror or group of mirrors 438b is configured to direct a second beam 416b to a second mirror or group of mirrors 442b of the second mirror array 426. During operation of the QIP system 200, the actuators 440a . . . 440n may reposition the mirrors 438a . . . 438n to reposition the beams in response to determining that the beams 416a-416d are not optimally addressing the trapped ions 272a . . . 272n.

For example, as shown in FIG. 4A, the optical and trap controller 220 may determine that the second beam 416b is not optimally addressing the ion 272n-1. In some aspects, the optical and trap controller 220 determines that a particular mirror or group of mirrors 442a . . . 442n should be repositioned in response to determining that the particular ion 272a . . . 272n is receiving less input than other ions 272a . . . 272n, is responding more slowly when flipping the qubits with the addressing beams 416a . . . 416d, more intensity than expected is needed to perform an operation with the qubits, and so forth. In response to this determination, the optical and trap controller 220 may command the actuator 440b coupled to the mirror or group of mirrors 438b to reposition the mirror or group of mirrors 438b to reposition the beam 416b to the position of the beam 416b′. As shown in FIG. 4, the repositioned beam 416b′ is substantially centered on the trapped ion 272n-1. Although the mirrors 438a . . . 438n are repositionable by the actuators 440a . . . 440n, the mirrors 438a . . . 438n are repositioned slowly. For example the mirrors 438a . . . 438n may be repositioned during a configuration sequence to align each of the mirrors 438a . . . 438n with a particular mirror 442a . . . 442n. The mirrors 438a . . . 438n may also be repositioned during operation of the QIP system 200, for example to compensate for drift. In some aspects, the optical and trap controller 220 determines that a particular mirror or group of mirrors 438a . . . 438n should be repositioned in response to determining that the particular ion 272a . . . 272n is receiving less input than other ions 272a . . . 272n, is responding more slowly when flipping the qubits with the addressing beam, more intensity than expected is needed to perform an operation, and so forth.

The second mirror array 426 includes a second plurality of mirrors 442a . . . 442n. Each of the mirrors or groups of mirrors 442a . . . 442n is mapped to one of the N ions 272a . . . 272n. Each of the mirrors 442a . . . 442n is coupled to an actuator 444a . . . 444n (FIG. 4A) configured to reposition the particular mirror 442a . . . 442n coupled to the particular actuator 444a . . . 444n. In the illustrated configuration, the actuators 444a . . . 444n include MEMS actuators. The actuators 444a . . . 444n are repositionable (e.g., by the optical and trap controller 220) and each configured to direct a beam 416a . . . 416d contacting one a particular one of the mirrors or groups of mirrors 442a . . . 442n to a particular one of the trapped ions 272a . . . 272n. For example, in the configuration illustrated in FIG. 4A, the first mirror or groups of mirrors 438a is oriented to direct the first beam 416a onto the ion 272n. The second mirror or group of mirrors 442b is oriented to direct the second beam 416b (or repositioned beam 416b′) onto the ion 272n-1. This is particularly advantageous for configurations in which the trapped ions 272a . . . 272n are unevenly spaced, because the angles of the mirrors 438a . . . 438n and the mirrors 442a . . . 442n can be customized based on the actual position of the ions 272a . . . 272n. For example, the actuators 444a . . . 444n may be configured to tune the angles of the mirrors 442a . . . 442n so that the beam 416a . . . 416d is telecentric at the ions 272a . . . 272n. For example the mirrors 442a . . . 442n may be repositioned during a configuration sequence to align each of the mirrors 442a . . . 442n with a particular ion 272a . . . 272n. The mirrors 442a . . . 442n may also be repositioned during operation of the QIP system 200, for example to compensate for drift. In some aspects, the optical and trap controller 220 determines that a particular mirror or group of mirrors 442a . . . 442n should be repositioned in response to determining that the particular ion 272a . . . 272n is receiving less input than other ions 272a . . . 272n, is responding more slowly when flipping the qubits with the addressing beam, more intensity than expected is needed to perform an operation, and so forth.

As shown in FIG. 4A, the number of mirrors or groups of mirrors 442a . . . 442n in the second plurality of mirrors 442 is the same as the number N of trapped ions 272a . . . 272n. In some aspects, the second mirror array 426 may be an array of quadratic mirrors, such that groups of mirrors 442a . . . 442n are configured to address each of the N ions 272a . . . 272n.

The lenses 430, 434 may be configured for beam size matching, magnification, and so forth on the beams 416a . . . 416d exiting the second mirror array 426. In some aspects, the lenses 430, 434 may be part of a larger optical relay.

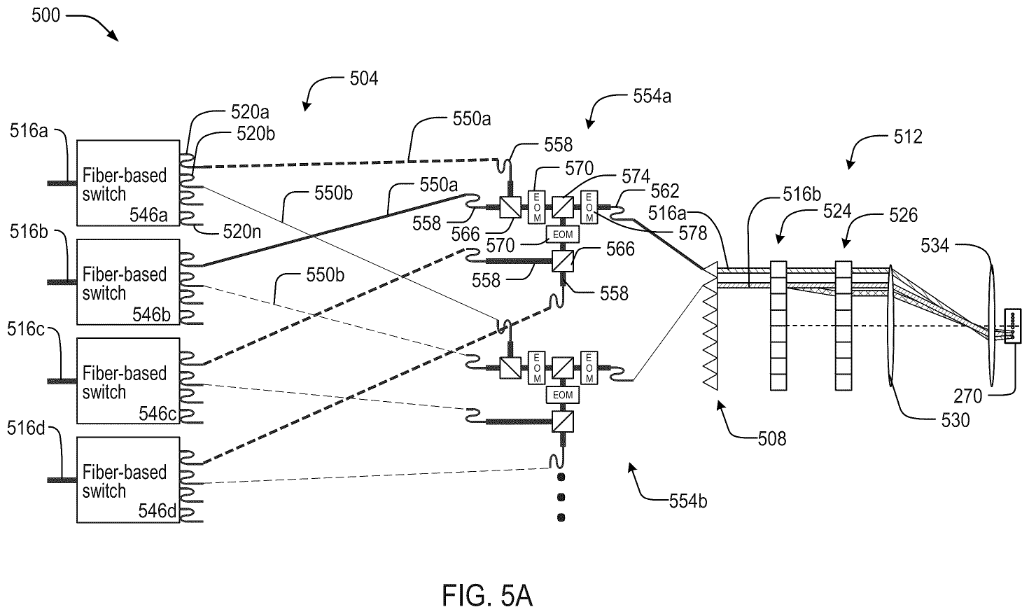

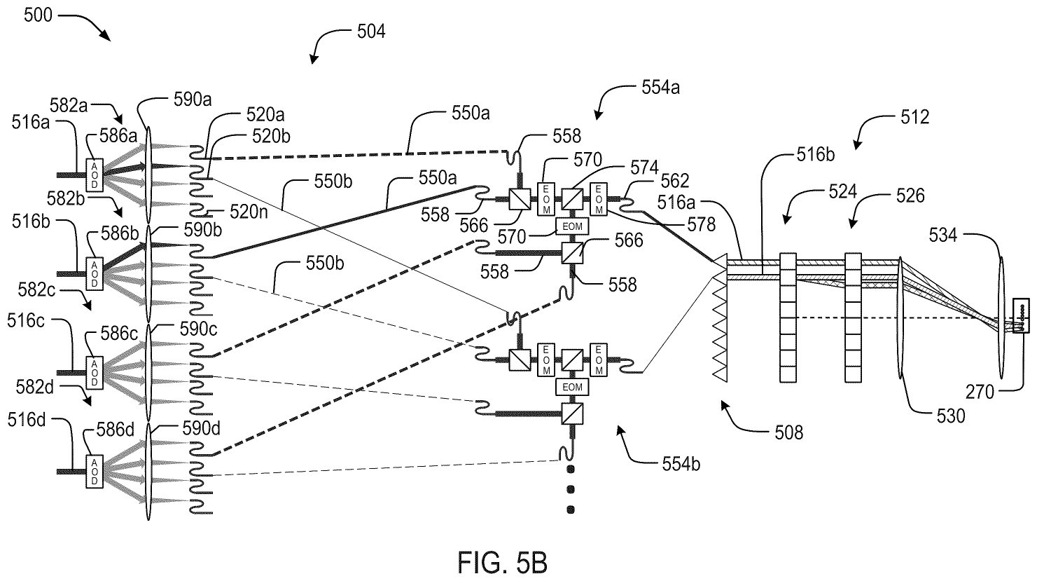

FIG. 5A illustrates another schematic representation of a M×N system 500 configured to address one or more qubits. The system 500 is configured to dynamically and flexibly switch M beams onto N different optical addressing channels 520a . . . 520n configured to address N trapped ions 272a . . . 272n in the ion trap 270. Such a configuration allows for simultaneous operation of M/2 2-qubit gates with laser power scaling proportionally to the number M of simultaneously existing addressing beams, while still allowing addressing of all N qubits simultaneously. The system 500 is substantially similar to the system 400, so will only be described in detail herein to the extent to which it differs from the system 400. Like numbers will be used to refer to like parts between the system 500 and the system 400. In operation in a QIP system, such as the QIP system 200, two systems 500 may be used. In such configurations, the second system 500 would be noncollinear with the system 500, such as on the opposite side of the ion trap 270 and symmetric to the systems 500 of FIGS. 5A and 5B, forming M pairs of counterpropagating beams.

In the configuration of FIG. 5A, an implementation of the fiber switchboard 504 is shown. In some aspects, the fiber switchboard 404 may include the features described with regard to the fiber switchboard 504 shown in FIG. 5A. The fiber switchboard 504 includes M fiber-based switches 546a-546d configured to receive and switch the M beams 516a-516d. In some aspects, the switches 546a-546d may include a plurality of mirrors configured to switch the beams 516a-516d between the N channels 520a . . . 520n. In the illustrated aspect, M equals four. In other aspects, there may be more or fewer M beams. In some aspects, each of the fiber-based switches 546a-546d is coupled to the N channels 520a . . . 520n and is configured to direct the beam 516a-516d to any of the N channels of the ion trap 270. For example, as shown in FIG. 5A, each of the fiber-based switches 546a-546d is coupled to first ends of N optical fibers. In other aspects, each of the fiber-based switches 546a-546d may be coupled to 1/M of the N channels 520a . . . 520n. In other aspects, the fiber-based switches 546a-546d can be coupled to the N channels 520a . . . 520n in different configurations.

In the illustrated aspects, the optical fibers 550a and 550b are shown, although the system 500 may include more optical fibers in other aspects (e.g., for configurations in which N is greater than 2). In some aspects, the fiber-based switches 546a-546d may be or include, for example, solid-state switches, fiber-AODs, fiber-AOMs, fiber electro-optic modulators (EOMs), Pockels cells, fiber MEMS devices, repositionable mirrors, and so forth. The fiber-based switches 546a-546d are configured to switch the respective beams 516a-516d between the optical fibers 550a, 550b, thereby switching the respective beams 516a-516d between the N channels 520a . . . 520n. For example, in some aspects the fiber-based switchboards 546a-546d may be positionable in a plurality of positions, with each position configured to align the beam 516a-516d, respectively, to a particular one of the N channels 520a . . . 520n and not the other N channels 520a . . . 520n. This allows the system 500 to only provide laser power to the particular channel N corresponding to the particular ion 270a . . . 270b being addressed by the beam 516a-516d. For example, the fiber-based switches 546a-546d may include mirrors that can be quickly repositioned to direct the beam 516a-516d to desired channels 520a . . . 520n. For example, in the aspect illustrated in FIG. 5A, active channels (e.g., channels through which the beam 516a-516d is being directed) are shown using solid lines and inactive channels (e.g., channels through which the beam 516a-516d is not being directed) are shown using dashed lines. In this configuration, the fiber-based switch 546a is configured such that the first channel 520a is inactive and the second channel 520b is active. In this configuration, the fiber-based switch 546b is configured such that the first channel 520a is active and the second channel 520b is inactive. The fiber-based switchboards 546c and 546d are inactive in the configuration shown in FIG. 5A.

The second ends of the N optical fibers 550a, 550b are coupled to N electro-optic —based fiber switches 554a, 554b. In some aspects, the electro-optic-based fiber switches 554a, 554b are EOM-based fiber switches or Pockels cell-based fiber switches. In the aspects illustrated herein, electro-optic-based fiber switches 554a, 554b are illustrated. In other aspects, the system 500 may include more electro-optic-based fiber EOM switches (e.g., in configurations in which N is greater than two). In some aspects, the electro-optic-based fiber switches 554a, 554b can switch the beams 516a-516d more quickly than switches having mechanically-moving components.

In the aspect shown in FIG. 5A, an electro-optic-based fiber switch 554a, 554b is positioned along each of the N channels. In the illustrated aspects, two electro-optic fiber switches 554a, 554b, although the system 500 may include more electro-optic-based switches in other aspects (e.g., for configurations in which N is greater than 2). Each of the electro-optic-based fiber switches 554a, 554b include inputs 558 coupled to optical fibers 550a, 550b, respectively. The optical fibers 550a, 550b coupled to a particular one of the electro-optic-based fiber switches 554a, 554b are coupled to the same output channel of each of the fiber-based switchboards 546a-546d. The electro-optic-based fiber switches 554a, 554b include outputs 562 configured to direct the beam 516a-516b to the particular one of the ions 272a . . . 272n aligned with the particular channel 520a . . . 520n. Each of the electro-optic-based fiber switches 554a, 554b includes a polarizing beam splitter (PBS) 566. The input and output fibers coupled to the PBS 566 are oriented such that two different input channels 520a . . . 520n are spatially overlapped after the PBS 566. A first EOM 570 is configured to change the polarization of the beam 516a-516d entering the electro-optic-based fiber switches 554a, 554b. For example, the first EOM 570 is configured to rotate the polarization (depending on which of the input channels 520a . . . 520n is in use) to allow the beam 516a to pass through the PBS 566 towards the desired output channel. In some aspects, changing the polarization of the beam 516a-516d may reduce a loss of laser power.

The beam 516a-516d exiting the first EOM 570 travels to a second PBS 574 that is configured to deflect the beam 516a-516d to a second EOM 578. In some aspects, the second EOM 578 is configured to change the polarization of the beam 516a-516d exiting the electro-optic-based fiber switches 554a, 554b. In some aspects, changing the polarization of the beam 516a-516d may reduce a loss of laser power. The beam 516a-516d exiting the electro-optic-based fiber switch 554a, 554b then travels to the v-groove fiber 508, which is aligned with the distortion correction system 512. The distortion correction system 512 redirects the particular beam 516a-516d to a particular ion 272a . . . 272n.

In operation, the system 500 is configured to receive M beams 516a-516d from a source such as a laser and dynamically switch the M beams 516a-516d between the N channels 520a . . . 520n aligned with the N qubits. For example, the QIP system 200 (e.g., via a controller such as the optical and trap controller 220) may determine that the first beam 516a should address the ion 270n-1. The optical and trap controller 220 can be configured to control and configure the first fiber-based switchboards 546a to switch the beam 516a to the second channel 520b. The beam 516a travels along the optical fiber 550b to the electro-optic-based fiber switch 554b. Within the electro-optic-based fiber switch 554b, the first PBS 566 directs the beam 516a to the first EOM 570. After exiting the first EOM 570, the second PBS 574 directs the beam 516a to the second EOM 578. After exiting the second EOM 578, the beam 516a travels to the v-groove fiber 508. The v-groove fiber array 508 aligns the beam 516a with the distortion correction system 512. The optical and trap controller 220 may control the position of the mirrors in the first mirror array 524 and the second mirror array 526 to correct the position and/or the tilt of the beam 516a such that the beam 516a is telecentric with regard to the ion 272n-1. In the configuration of FIG. 5A, the first channel 520a of the first switchboards 546a is inactive (e.g., the beam 516a is not directed to the first channel 520a). Therefore, the fiber switchboard 504 leads to large laser power savings in the system 500 relative to conventional systems without switched addressing breams.

With continued reference to the operation of FIG. 5A, the QIP system 200 (e.g., via the optical and trap controller 220) can be configured to determine that the second beam 516b should address the ion 270n. The optical and trap controller 220 can be configured to control the second fiber-based switchboards 546b to switch the beam 516b to the first channel 520a. The beam 516b travels along the optical fiber 550a to the electro-optic-based fiber switch 554a. Within the electro-optic-based fiber switch 554a, the first PBS 566 directs the beam 516b to the first EOM 570. After exiting the first EOM 570, the second PBS 574 directs the beam 516b to the second EOM 578. After exiting the second EOM 578, the beam 516b travels to the v-groove fiber array 508. The v-groove fiber array 508 aligns the beam 516b with the distortion correction system 512. The optical and trap controller 220 can control the position of the mirrors in the first mirror array 524 and the second mirror array 526 to correct the position and/or the tilt of the beam 516b such that the beam 516b is telecentric with regard to the ion 272n. In the configuration of FIG. 5A, the second channel 520b of the second switchboards 546b is inactive (e.g., the beam 516b is not directed to the second channel 520b). Therefore, the fiber switchboard 504 leads to large laser power savings in the system 500 relative to conventional systems without switched addressing breams.

FIG. 5B illustrates schematic representation of a variant of the M×N system 500 configured to address one or more qubits. The variant shown in FIG. 5B is substantially similar to the variant of FIG. 5A, so will only be described in detail herein to the extent to which it differs from FIG. 5A.

In the configuration of FIG. 5B, an implementation of the fiber switchboard 504 is shown. In some aspects, the fiber switchboard 404 may include the features described with regard to the fiber switchboard 504 shown in FIG. 5B. The fiber switchboard 504 includes switches 582a-582d (e.g., beam channel controllers) that are configured to receive the beams 516a-516d from the source. Each switch 582a-582d includes an AOD 586 and a lens 590. The AODs 586a-586d are configured as N-splitters. The AODs 586a-586d are configured such that changing an RF frequency applied to the AOD 586a-586d changes a steering angle of the AOD 586a-586d to direct the beam 516a-516d to a particular channel 520a . . . 520n. The beams 516a-516d may travel in free space from the switches 582a-582d to the channels 520a . . . 520n. Once the beam 516a-516d has been directed to a particular channel 520a . . . 520n, the beams 516a-516d are directed to the ions 272a . . . 272n as described above with regard to FIG. 5A.

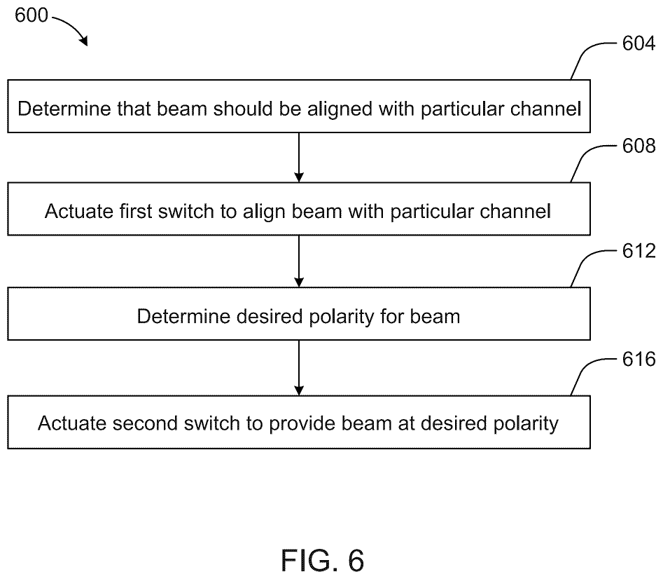

FIG. 6 illustrates a method for directing (or redirecting) one or more beams 516a . . . 516d onto the trapped ions 272a . . . 272n. Although the method 600 is described with regard to the first beam 516a, the method 600 can be used for any of the beams 516a . . . 516n. Further, although the method 600 is described with regard to the systems 500, the method 600 can also be used for the system 400.

At 604, a controller such as the general controller 205, optical and trap controller 220, and so forth, determines that the beam 516a should be aligned with a particular channel 520a . . . 520n aligned with a particular ion 272a . . . 272n.

At 608, the fiber-based switch 546a is actuated such that the beam 516a is aligned with the particular channel 520a . . . 520n. For example, in aspects in which the switch 546a includes a plurality of mirrors, one or more of the plurality of mirrors is positioned such that the beam 516a is aligned with the particular channel 520a . . . 520n. In another example, in aspects in switch 546a includes the AOD 586 and the lens 590, the RF frequency applied to the AOD 586 is changed to orient the steering angle of the AOD 586 such that the beam 516a is aligned with the particular channel 520a . . . 520n.

At 612, a desired polarity of the particular addressing beam 516a is determined. For example, the desired polarity of the particular addressing beam 516a may be determined by the algorithms component 210 and effected by the optical and trap controller 220.

At 616, the electro-optic-based fiber switch 554a is actuated to configure the beam 516a at the desired polarity. For example, the first EOM 570 may rotate the polarization of the beam 516a entering the electro-optic-based fiber switch 554a to pass through the PBS 556 toward the particular output channel 520a . . . 520n. A second EOM 570 may change the polarity of the beam exiting the electro-optic-based fiber switch 554a.

Steps 604-616 may be repeated multiple times during the method 600 such that the beam 516a can address different ions 272a . . . 272n via the channels 520a . . . 520n.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A quantum information processing (QIP) system including:
a laser source configured to generate one or more addressing beams; and
a fiber switchboard configured to dynamically switch at least one of the one or more addressing beams between a plurality of channels that are aligned with one or more qubits, respectively, in an ion trap,
wherein the one or more addressing beams includes a first addressing beam and the plurality of channels includes a first channel and a second channel, and
wherein the fiber switchboard has a first orientation in which the first addressing beam is aligned with the first channel and not aligned with the second channel and a second orientation in which the first addressing beam is aligned with the second channel and not aligned with the first channel.

2. The QIP system of claim 1, wherein the fiber switchboard includes one or more first switches configured to dynamically switch the one or more addressing beams between the plurality of channels, and wherein the one or more first switches include one or more of a solid-state switches, a fiber-acousto-optic deflector (AOD), a fiber acousto-optic modulator (AOM), a fiber electro-optic modulators (EOM) fiber-microelectromechanical (MEMS) devices, and repositionable mirrors.

3. The QIP system of claim 1, wherein the fiber switchboard includes one or more first switches configured to dynamically switch the one or more addressing beams between the plurality of channels, and one or more second switches configured to change a polarization of the one or more addressing beams.

4. The QIP system of claim 1, further comprising a distortion correction system configured to change one or more of a position and a tilt of the one or more addressing beams.

5. The QIP system of claim 4, wherein the distortion correction system comprises:
a first mirror array configured to change a position of the one or more addressing beams relative to one or more qubits in an ion trap; and
a second mirror array, wherein the first mirror array is configured to direct the one or more addressing beams to the second mirror array, and wherein the second mirror array is configured change a tilt of the one or more addressing beams relative to the one or more qubits in the ion trap.

6. The QIP system of claim 5, wherein the first and second mirror arrays are configured to compensate for aberrations, drift, or vibrations in the QIP system.

7. The QIP system of claim 1, wherein a number of the one or more addressing beams is smaller than an number of channels of the plurality of channels.

8. The QIP system of claim 1, wherein the laser source does not provide laser power to the plurality of channels that are not aligned with the one or more of addressing beams.

9. A quantum information processing (QIP) system including:
a laser source configured to generate M number of addressing beams, wherein M is at least one; and
a fiber switchboard configured to dynamically realign at least one of the M number of addressing beams from a first channel to a second channel of a plurality of channels that are aligned with one or more qubits, respectively, in an ion trap, wherein the plurality of channels includes N number of channels; and
wherein the number M of addressing beams is less than the number N of channels.

10. The QIP system of claim 9, wherein the laser source does not provide power to the plurality of the N channels that are not aligned with the M of addressing beams.

11. The QIP system of claim 9, wherein the fiber switchboard includes one or more switches configured to dynamically switch the M number of addressing beams between the N number plurality of channels, and wherein the each of the one or more switches is configured such that when a particular one of the M number of addressing beam is aligned with a particular one of the N number of channels, that particular addressing beam is not aligned with the other N number of channels in the plurality of channels.

12. The QIP system of claim 9, wherein the switch is a first switch, and wherein the fiber switchboard includes one or more second switches configured to change a polarization of the one or more addressing beams.

13. The QIP system of claim 12, wherein the second switches include electro-optic-based fiber switches.

14. A quantum information processing (QIP) system includes a processor and a memory, the processor configured to execute computer executable instructions in the memory to:
determine that a particular addressing beam of one or more addressing beams should be aligned with a particular channel of a plurality of channels, wherein each of the plurality of channels is aligned with a particular qubit in an ion trap; and
actuate a switch of a fiber switchboard to align the particular addressing beam with the particular channel, wherein the switch includes a plurality of positions configured to align the particular addressing beam with one of the plurality of channels while not aligning the particular addressing beam with the others of the plurality of channels.

15. The QIP system of claim 14, wherein the switch is a first switch, and wherein the instructions further comprise:
determining a desired polarity of the particular addressing beam;
controlling a second switch of the fiber switchboard to configure the particular addressing beam at the desired polarity.

16. The QIP system of claim 15, wherein providing the particular addressing beam at the desired polarity includes commanding the second switch to change the polarity of the particular addressing beam.

17. The QIP system of claim 14, wherein an amount of the one or more addressing beams is smaller than an amount of channels of the plurality of channels.

18. The QIP system of claim 14, wherein the particular channel of the plurality of channels is a first particular channel, and whether the computer executable instructions further include instructions to:
determine that the particular addressing beam should be aligned with a second particular channel of a plurality of channels; and
actuate the switch to align the particular addressing beam with the second particular channel, wherein the particular addressing beam is not aligned with the first particular channel when the particular addressing beam is aligned with the second particular channel.

19. The QIP system of claim 14, wherein the switch includes one or more of a solid-state switches, a fiber-acousto-optic deflector (AOD), a fiber acousto-optic modulator (AOM), a fiber electro-optic modulators (EOM) fiber-microelectromechanical (MEMS) devices, and repositionable mirrors.
